(19) United States
(12) Patent Application Publication
(10) Pub. No.: US 2025/0053127 A1
(43) Pub. Date: Feb. 13, 2025

(54) DEVELOPING DEVICE AND IMAGE FORMING APPARATUS

(71) Applicant: CANON KABUSHIKI KAISHA, Tokyo (JP)

(72) Inventors: NAOKI MUGITA, Ibaraki (JP); NAOTO KUBO, Chiba (JP)

(21) Appl. No.: 18/757,938

(22) Filed: Jun. 28, 2024

(30) Foreign Application Priority Data
Aug. 8, 2023 (JP) 2023-129142

(51) Int. Cl. G03G 15/00

(52) U.S. Cl. CPC G03G 15/556; G03G 15/5004; G03G 15/80

(57) ABSTRACT

Disclosed is a developing device detachably attachable to an image forming apparatus. The developing device includes a storing portion that stores information on output characteristics of a power supply of an image forming apparatus that has performed an initializing mode for determining a control voltage to be applied to a magnetic permeability sensor by the power supply of the image forming apparatus in order to detect a toner density of developer accommodated in the developing device.

### BACKGROUND OF THE INVENTION

### Field of the Invention

This invention relates to a developing device that develops an electrostatic latent image formed on an image bearing member using developer, and to an image forming apparatus with the developing device.

### Description of the Related Art

As an image forming apparatus such as a printer and a copying machine, known are a dual-component developing device in which development is performed using two-component developer that includes carrier and toner, and a mono-component developing device in which development is performed using mono-component developer that includes only toner.

Usually, a dual-component developing device has a magnetic roller constituted by a magnet member having multiple magnet poles inside and a rotatably supported cylindrical developer bearing member. In a dual-component developing device, dual-component developer that includes magnetic carrier to which toner is attached is borne on a developer bearing member and is conveyed to a developing area which is a portion opposed to an image bearing member to supply toner to the image bearing member by forming a magnetic brush, so that an electrostatic latent image is developed. In such a dual-component developing device, toner is charged by the magnetic carrier and the toner being agitated and mixed and the charging of toner becomes stable to obtain a relatively stable and a high quality image.

However, in the dual-component developing device, the toner density changes according to the consumption of toner so that the mixture rate of toner and magnetic carrier changes. Therefore, it is necessary to provide a toner density control device for replenishing toner as needed.

A magnetic permeability sensor (also referred to as an inductance sensor) is provided for detecting a toner density in the developing device. The magnetic permeability sensor is configured to be able to output a voltage according to the magnetic permeability of the developer by being applied a voltage. In the following, a voltage applied to the magnetic permeability sensor is referred to as a control voltage. A difference in the relationship between the control voltage and the output voltage respectively occurs in magnetic permeability sensors attached to a developing device due to variations of magnetic permeability sensors themselves, variations in implementation of magnetic permeability sensors, and variations in the control voltage applied to magnetic permeability sensors. Namely, even if the same control voltage is applied to the same magnetic permeability sensors in case of the same toner density, different voltages may be output from the magnetic permeability sensors attached to the developing device. As a result, different values may be detected as toner density regardless of the same toner densities, causing an erroneous detection of the toner density.

Conventionally, when a new developing device is installed and used at an image forming apparatus, a control process for initializing the magnetic permeability sensor is performed to properly detect the toner density. In the control process for initializing the magnetic permeability sensor, the developer is spread all over the developing device by driving a conveying screw provided in the developing device, thereafter the control voltage applied to the magnetic permeability sensor is changed, and a corresponding output voltage is obtained. The developer whose toner density is adjusted to a target density is accommodated in a new developing device, when shipped from the factory. Therefore, in the control process for initializing the magnetic permeability sensor, a control voltage when the output voltage corresponding to the target density is obtained is set to the control voltage to be applied to the magnetic permeability sensor for properly detecting the toner density. Namely, by performing the control process for initializing the magnetic permeability sensor when a new developing device is installed and used, the toner density can be properly detected.

In contrast, when a second hand developing device detached from an image forming apparatus is installed and re-used in another image forming apparatus, the presence and the toner density of the developer are unknown. Therefore, the above-described control process for initializing the magnetic permeability sensor cannot be performed. Even if it is performed, the toner density cannot be properly detected.

Japanese Patent Application Laid-Open No. 2008-96763 discloses the technology for resetting the control voltage according to the difference of the linear velocities of the apparatus before and after the exchange based on the set value of the control voltage determined in the initializing control process when a second hand developing device detached from an image forming apparatus is installed and re-used in another image forming apparatus.

However, the variations in the control voltage applied to the magnetic permeability sensor differ depending on the respective image forming apparatuses. Therefore, the set values of the control voltage determined in the control process for initializing the magnetic permeability sensor change depending on the respective image forming apparatuses. Therefore, in the technology disclosed in the Japanese Patent Application Laid-Open No. 2008-96763, the toner density cannot be properly detected due to the existence of the deviation in the toner density for the variations of the control voltage applied to the magnetic permeability sensor, causing an image defect such as a foggy image.

### SUMMARY OF THE INVENTION

The object of the present invention is to properly detect the toner density of the developer.

A representative configuration of the present invention is a developing device detachably attachable to an image forming apparatus, comprising:
a developer bearing member that bears developer including toner and carrier for developing an electronic latent image formed on an image bearing member;
a developing container that accommodates the developer;
a magnetic permeability sensor capable of outputting an output voltage according to a toner density of the developer accommodated in the developing container by a voltage being applied to the magnetic permeability sensor; and
a storing portion that stores information on output characteristics of a power supply of an image forming apparatus that has performed an initializing mode for determining a control voltage applied to the magnetic permeability sensor by the power supply of the image forming apparatus in order to detect a toner density of the developer accommodated in the developing device.

Another representative configuration of the present invention is an image forming apparatus comprising:
an image bearing member;
a developing device detachably attachable to the image forming apparatus, the developing device comprising: a developer bearing member that bears developer including toner and carrier for developing an electronic latent image formed on the image bearing member; a developing container that accommodates the developer; a magnetic permeability sensor capable of outputting an output voltage according to a toner density of the developer accommodated in the developing container by a voltage being applied to the magnetic permeability sensor; and a storing portion;
a power supply that applies a voltage to the magnetic permeability sensor;
a main body storing portion that stores information on output characteristics of the power supply; and
a control portion capable of performing an initializing mode for determining a control voltage applied to the magnetic permeability sensor by the power supply in order to detect a toner density of the developer accommodated in the developing device by detecting an output voltage output from the magnetic permeability sensor to which the power supply applies the voltage,
wherein in a case where the initializing mode has not been performed for the developing device attached to the image forming apparatus, the control portion performs the initializing mode, and the control portion reads out the information on output characteristics of the power supply stored in the main body storing portion and stores in the storing portion the information as information on output characteristics of a power supply of an image forming apparatus that has performed the initializing mode.

Further features of the present invention will become apparent from the following description of exemplary embodiments with reference to the attached drawings.

### BRIEF DESCRIPTION OF THE DRAWINGS

FIG. 1 is a schematic cross-sectional diagram showing the overall configuration of an image forming apparatus.

FIG. 2 is a schematic cross-sectional diagram showing the configuration of an image forming portion of the image forming apparatus.

FIG. 3 is a block diagram showing the system configuration of the control of the image forming apparatus.

FIG. 4 is a schematic diagram showing a cross-sectional view of a developing device.

FIG. 5 is a schematic diagram showing a top surface view of the developing device.

FIG. 6 is a schematic diagram showing a replenishing device.

FIG. 7 is a graph showing the relationship between the output voltage and the toner density of a magnetic permeability sensor.

FIG. 8 is a flowchart of the control process of initializing the developing device.

FIG. 9 is a block diagram showing the system configuration of the toner replenishing control of the image forming apparatus.

FIG. 10 is a graph showing the sensitivity characteristics of individual magnetic permeability sensors.

FIG. 11 is a diagram showing a table of control voltages to the magnetic permeability sensors.

FIGS. 12A and 12B is a flowchart of adjusting the control voltages to the magnetic permeability sensors according to Embodiment 1 of the present invention.

FIG. 13 is a diagram showing a table of adjustment result of the control voltages to the magnetic permeability sensors in Embodiment 1 of the present invention.

FIG. 14 is a graph showing the characteristics of the voltage of a sensor power supply and control portion according to Embodiment 2 of the present invention. The voltage is applied to a magnetic permeability sensor.

FIGS. 15A and 15B is a flowchart of adjusting the control voltages to the magnetic permeability sensors according to Embodiment 2 of the present invention.

FIG. 16 is a graph showing the relationship between the control voltage and the output voltage of the magnetic permeability sensor according to Embodiment 2 of the present invention.

FIG. 17 is a diagram showing a table of adjustment result of the control voltages to the magnetic permeability sensors according to Embodiment 2 of the present invention.

### DESCRIPTION OF THE EMBODIMENTS

Hereinafter, with reference to the drawings, preferrable embodiments of the present invention will be described in detail. However, the dimensions, materials, shapes, and relative arrangement of the components described in the following embodiments should be changed as appropriate depending on the configuration and various conditions of the apparatus to which the invention is applied, and it is not intended to limit the scope of the invention to them alone.

### Embodiment 1

An image forming apparatus according to Embodiment 1 will be described in detail referring to figures.

### Overall Configuration and Operation of Image Forming Apparatus

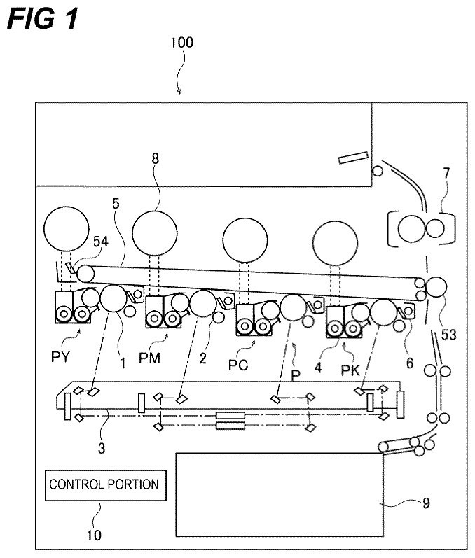

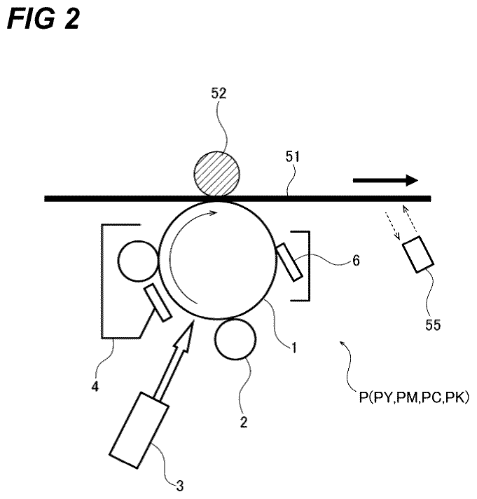

First, the overall configuration and operation of an image forming apparatus according to Embodiment 1 of the present invention will be described. FIG. 1 is a schematic cross-sectional diagram showing the overall configuration of an image forming apparatus with an electrophotographic system. FIG. 2 is a schematic cross-sectional diagram showing the configuration of an image forming portion of the image forming apparatus.

The image forming apparatus 100 according to the present embodiment forms an image on a recording material according to the image information from a host device such as a personal computer communicably connected to a document reader connected the main body of the image forming apparatus 100 or to the image forming apparatus 100. For example, a full four-color image of yellow (Y), magenta (M), cyan (C), and black (K) is formed on the recording material such as a recording sheet, a plastic sheet, and a cloth using image forming means of an electrophotographic system.

The image forming apparatus 100 of the present embodiment is a four-tandem type image forming apparatus having four image forming portions PY, PM, PC, and PK for respectively forming images of yellow, magenta, cyan, and black. While the intermediate transfer belt 51 (as an intermediate transfer member) of the transfer device 5 moves in the direction of the arrow of FIG. 2 and passes through the respective image forming portions PY to PK, the images of respective colors are superimposed on the intermediate transfer belt 51 at the respective image forming portions PY to PK. By transferring multiple toner images superimposed on the intermediate transfer belt 51 onto the recording medium, a recording image is obtained.

The configurations of the image forming portions PY, PM, PC, and PK are substantially the same as each other except for the developing color. Therefore, suffixes Y, M, C, and K, which are added for indicating a component belonging to corresponding image forming portions PY, PM, PC, and PK will be omitted and collectively described like an image forming portion P when there is no need to distinguish the components.

The image forming portion P has the photosensitive drum 1 constituted by a drum-shaped photosensitive member as an electrostatic latent image bearing member that bears an electrostatic latent image according to image information. Around the surface of the outer circumference of the photosensitive drum 1, the charging roller 2 as a charging device, the exposure device 3 constituted by a laser exposure optic system, the developing device 4, the transfer device 5, and the cleaning device 6. The toner accommodating container 8 (toner cartridge) is an exchangeable container for accommodating developer to be replenished to the developing device 4. The transfer device 5 has the intermediate transfer belt 51 as an intermediate transfer member. The intermediate transfer belt 51 is wound around multiple rollers and rotates in the direction of the arrow indicated in FIG. 2. The primary transfer member 52 is disposed via the intermediate transfer belt 51 at the position to which the photosensitive drum 1 is opposed. The second transfer member 53 is provided at the position to which one of the rollers around which the intermediate transfer belt 51 is wound is opposed.

When forming an image, first, the surface of the rotating photosensitive drum 1 is uniformly charged by the charging roller 2. Next, an electrostatic latent image is formed on the photosensitive drum 1 by the exposure device 3 performing a scanning exposure according to image information signal. The electrostatic latent image formed on the photosensitive drum 1 is visualized into a toner image developed by the developing device 4 with toner of the developer.

The toner image formed on the photosensitive drum 1 is primarily transferred onto the intermediate transfer belt 51 at the primary transfer nip portion where the photosensitive drum 1 abuts on the intermediate transfer belt 51 by the effect of a primary transfer bias voltage applied to the primary transfer member 52. When a four full-color image is formed, toner images are transferred from the respective photosensitive drums 1 sequentially in the order from the image forming portion PY so that multiplexed toner image including superimposed toner images of four color is formed on the intermediate transfer belt 51.

On the other hand, a recording material accommodated in the sheet cassette 9 is conveyed by a pickup roller, conveying rollers, and registration rollers to the secondary transfer nip portion where the secondary transfer member 53 abuts on the intermediate transfer belt 51 in synchronism with the toner image on the intermediate transfer belt 51. Then, the multiplexed toner image on the intermediate transfer belt 51 is transferred onto the recording material at the secondary transfer nip portion by the effect of a secondary transfer bias voltage applied to the secondary transfer member 53.

Thereafter, the recording material separated from the intermediate transfer belt 51 is conveyed to the fixing device 7. The toner image transferred onto the recording material is melted and mixed by being heated and pressed by the fixing device 7 to be fixed onto the recording material. Thereafter, the recording material is discharged from the image forming apparatus.

The adhering substance such as toner remaining on the photosensitive drum 1 after the primary transfer process is collected by the cleaning device 6. Thereby, the photosensitive drum 1 is prepared for the next image forming process. Further, the adhering substance such toner remaining on the intermediate transfer belt 51 after the secondary transfer process is removed by the intermediate transfer member cleaner 54.

Further, the image forming apparatus 100 according to the present embodiment is capable of forming a monochrome or multi-color image by using an image forming portion for a desired monochrome such as black monochrome image or by using several image forming portions for several colors out of the four colors.

### Control Portion

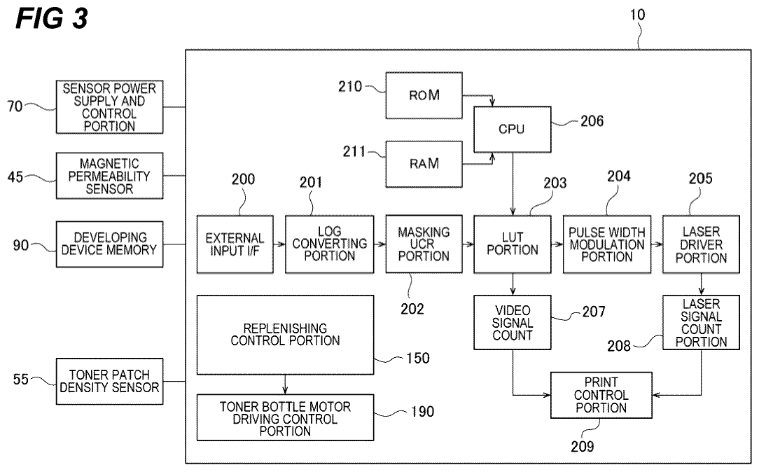

As indicated in FIG. 3, the image forming apparatus 100 according to the present embodiment has the control portion 10 that controls the operations of the respective parts of the image forming apparatus 100. The configuration of the control portion 10 will be described referring to FIGS. 2 and 3. FIG. 3 is a block diagram showing the system configuration for the control of the image forming apparatus 100. The photosensitive drum, the charging roller, the laser emitting device, the developing device, the primary transfer roller, the cleaner, the intermediate transfer belt, the fixing device, the motors that drive these components, and the power source are connected to the control portion 10. However, these components are not relevant to the gist of the present invention and the illustration and description of these components are omitted. Further, the image forming portion PK is taken as an example for the easy understanding of the description.

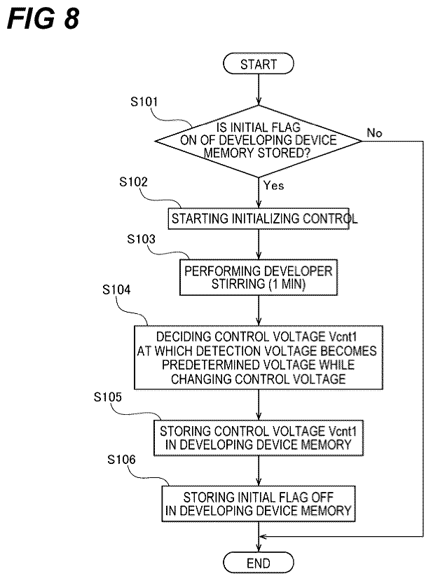

The control portion 10 as control means has the CPU (Central Processing Unit) 206, the ROM (Read Only Memory) 210, the RAM (Random Access Memory) 211. The various programs and various data are stored in the ROM 210. The various programs include ones for the image forming job process, replenishing control process for replenishing toner to the developing device 4K, the initializing control process for magnetic permeability sensor 45 (see FIG. 8). The CPU 206 is capable of executing the various programs stored in the ROM 210 to operate the image forming apparatus 100. Working data and input data are stored in the RAM 211 as a main body memory portion. The CPU 206 is capable of referring to the data stored in the RAM 211 based on the various programs.

In the present embodiment, the magnetic permeability sensor 45, and the sensor power supply and control portion 70 that supplies a voltage to the magnetic permeability sensor 45 and inputs the output value from the magnetic permeability sensor 45 are connected to the control portion 10. The sensor power supply and control portion 70 includes a power supply that applies a power supply voltage to the magnetic permeability sensor 45 and applies a control voltage (Vent) with the power supply voltage applied. The magnetic permeability sensor 45 is capable of outputting an output voltage whose value changes depending on the toner density of the developer accommodated in the developing device 4K in the state in which the voltages are applied by the sensor power supply and control portion 70.

The control portion 10 has the replenishing control portion 150. The replenishing control portion 150 controls the toner bottle motor driving control portion 190 such that the replenishing agent is replenished from the toner accommodating container 8 to the developing device 4K in order to maintain a toner density of the developer accommodated in the developing device 4K to the target density based on an output voltage output from the magnetic permeability sensor 45. The detail of the control of replenishing amount will be described later.

The external input interface 200 (external input I/F) is connected to an external device (not shown) such as a document reading device and a computer such that the data communication between the external input interface 200 and the external device is possible. Color image data in the form of RGB are input via the external input interface 200 from the external device as needed. The LOG converting portion 201 converts the brightness data of the image data in the form of RGB input via the external input interface 200 into the density data in the form of CMYK (CMYK image data) based on the lookup table (LUT) stored in the ROM 210. The masking/UCR portion 202 extracts black (Bk) component data from the converted CMYK image data, and performs matrix operation on the CMYK image data to adjust color muddiness of the recording color material.

The LUT portion (lookup table portion) 203 is for conforming the CMYK image data with the ideal tone characteristics of the printer control portion 209. Specifically, the density of each color of the CMYK image data input from the masking/UCR portion 202 is adjusted using the lookup table. The lookup table is made based on the data loaded on the RAM 211 and the content of the table is set by the CPU 206. The pulse width modulation portion 204 outputs a pulse signal with a pulse width corresponding to the level of the CMYK image data input from the LUT portion 203. The laser driver 205 drives the laser emitting device 3K based on this pulse signal so that the photosensitive drum 1K is irradiated with the laser beam to form an electrostatic latent image on the photosensitive drum 1K (see FIG. 1).

The video signal count portion 207 accumulates the levels (0 to 255 levels) of each pixel in 600 dpi of the image data input to the LUT portion 203 for one image surface. The image data accumulated value is referred to as video count value. When all of the output image are of “255” level for example in an A4 single sheet, the maximum value of a video count value is “529”. When there is a constraint on the configuration of the circuit, the laser signal count portion 208 can be used instead of the video signal count portion 207 to obtain a video count value by calculating the image signal from the laser driver 205 in the same way. The signal indicating a video count value is input to the printer control portion 209. The printer control portion 209 performs various controls such as a control of rotational speeds of the developer bearing member 44 and the screw members 41d, 41e based on this signal.

### Basic Configuration of Developing Device

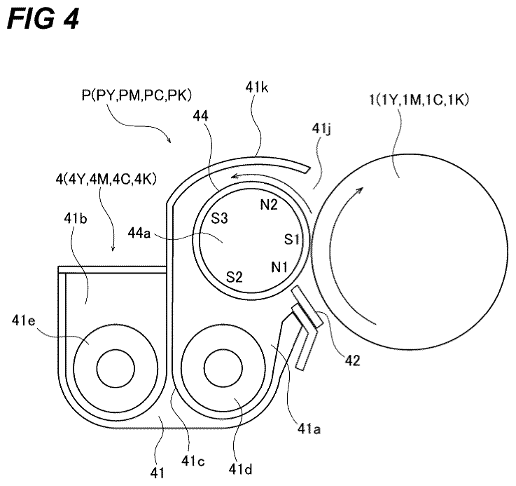

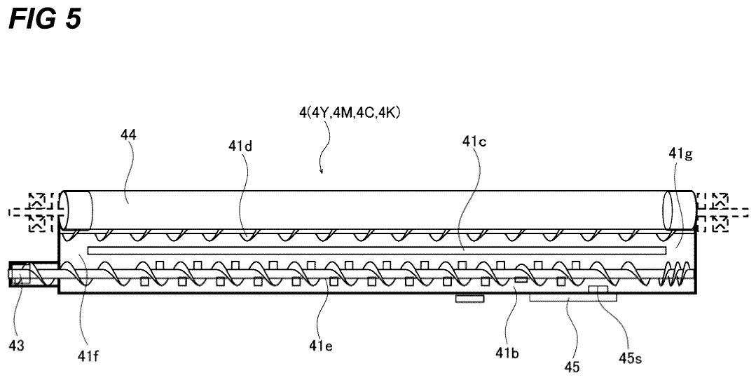

The configuration of the developing device 4 will be described referring to FIGS. 4 and 5. FIG. 4 is a schematic diagram showing a cross-sectional view of the developing device. FIG. 5 is a schematic diagram showing a top surface view of the developing device.

The configurations of the image forming portions PY, PM, PC, and PK are substantially the same as each other except for the developing color. Therefore, suffixes Y, M, C, and K, which are added for indicating a component belonging to corresponding image forming portions PY, PM, PC, and PK will be omitted and collectively described like an image forming portion P.

The developing device 4 has the developing container 41 for accommodating dual-component developer having non-magnetic toner and magnetic carrier. The developer accommodated in the developing container 41 according to the present embodiment is dual-component developer in which negatively charged non-magnetic toner and magnetic carrier are mixed. Non-magnetic toner is made by encapsulating colorants, wax components, etc. in resin such as polyester, styrene, etc., and grinding or polymerizing them into powder. The resin also contains crystalline polyester, which has a low melting point and enables low-temperature fixing. Magnetic carriers have a resin coating on the surface layer of a core made of resin particles mixed with ferrite particles or magnetic powder.

The developer bearing member 44 and the magnet roll 44a constituted by magnet as magnetic field generating means fixed in the developer bearing member 44 are provided in the developing container 41. Further, the restricting blade 42 that forms a thin layer of developer on the surface of the developer bearing member 44, and the screw members 44d, 41e that stir and convey the developer in the developing container 41 are disposed in the developing container 41.

The inside of the developing container 41 is divided by the partition wall 41c extending in the vertical direction into the developing chamber 41a and the stirring chamber 41b. The screw member 41d is disposed in the developing chamber 41a and the screw member 41e is disposed in the stirring chamber 41b. The passing-over portions 41f and 41g that allow the developer to pass between the developing chamber 41a and the stirring chamber 41b are disposed at both end portions of the partition wall 41c in the longitudinal direction.

In the present embodiment, the screw members 41d and 41e are formed to have spiral blades as conveying portions on magnetic shafts (rotating shafts). The screw member 41e has stirring ribs that protrude from the shaft in the radial directions in addition to the spiral blade. The stirring ribs have a predetermined width in the conveying direction of the developer and stir the developer according to the rotation of the shaft.

The screw member 41d stirs and conveys the developer in the developing chamber 41a. The screw member 41e is used for homogenizing the toner density under the Automatic Toner Replenisher (ATR) control. Namely, the replenishing developer with toner and carrier replenished from the replenishing port 43 and the developer with toner and magnetic carrier already present in the stirring chamber 41b are stirred and conveyed by the screw member 41e to homogenize the toner density.

The screw members 41d and 41e are disposed along the direction of the rotational axis of the developer bearing member 44 such that the screw members 41d and 41e are substantially parallel with each other. The screw members 41d and 41e convey the developer along the rotating axis in the directions that are opposite to each other. In this way, the developer circulates in the developing container 41 via the passing-on portions 41f and 41g by the screw members 41d and 41e. Namely, the developer in the developing chamber 41a whose toner density has decreased by consuming toner in the developing process is moved to the stirring chamber 41b via the passing-on portion 41f by the conveying forces of the screw members 41d and 41e.

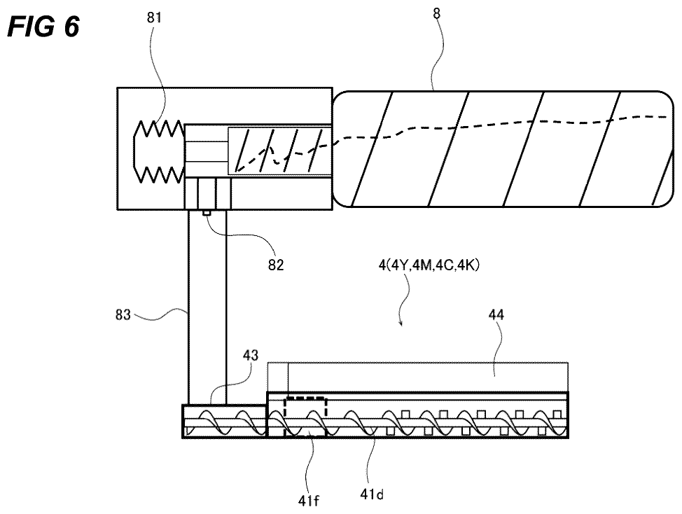

At the most upstream portion of the stirring chamber 41b, the replenishing port 43 for replenishing toner is provided to communicate with the toner accommodating container 8 indicated in FIG. 6 as a replenishing container in which replenishing toner is accommodated. The operation of the toner accommodating container 8 is controlled by the ATR control according to the image ratio, the detection result of the magnetic permeability sensor 45 as a toner density sensor, the density detection result of the toner patch density sensor 55 for a patch image during image formation to replenish toner to the most upstream portion of the stirring chamber 41b. The toner is replenished to the developer in the stirring chamber 41b and the developer is stirred. Thereafter the developer is moved to the developing chamber 41a via the passing-over portion 41g. The opening portion 41j of the developing chamber 41a of the developing device 4 is provided at the position corresponding to the developing region that is opposed to the photosensitive drum 1. The developer bearing member 44 is rotatably provided such that the developer bearing member 44 is partially exposed from the opening portion 41j of the developing container 41. In the present embodiment, the developer bearing member 44 is constituted by non-magnetic material and rotates in the direction of the arrow indicated in FIG. 4 during the developing operation. Inside the developer bearing member 44, the magnet roll 44a is fixed. The magnet roll 44a has multiple magnetic poles along the circumferential direction as magnetic field generating means.

The developer in the developing chamber 41a is supplied to the developer bearing member 44 by the screw member 41d. The predetermined amount of developer out of the developer supplied to the developer bearing member 44 is borne on the developer bearing member 44 by the magnet pole S2 for attraction of the magnet roll 44a to form a developer bank. The dual-component developer on the developer bearing member 44 is conveyed to the magnetic pole N1 for layer width restriction by the rotation of the developer bearing member 44, where the layer width is restricted by the restricting blade 42 and is further conveyed to the developing area opposed to the photosensitive drum 1. In the developing area, the developer on the developer bearing member 44 forms a magnetic brush by the magnetic pole S1 for development.

In the developing area, the developer touches the photosensitive drum 1 so that the toner is supplied to an electrostatic latent image formed on the photosensitive drum 1 to form a toner image. In this case, in order to improve the developing efficiency, i.e., the toner providing rate to the electrostatic latent image, a developing voltage in which a direct current voltage and an alternating current voltage are superimposed is applied to the developer bearing member 44 by a power supply (not shown). For example, the alternating current voltage with the peak to peak voltage of 1500 [V] and frequency of 12 [kHz] is superimposed with the direct current voltage of −500 [V] is applied as the developing voltage. Generally, in the dual-component magnetic brush developing method, when an alternating current voltage is applied, the developing efficiency increases and the quality of an image becomes higher but a fog is easier to happen. Therefore, a potential difference is set between the direct current voltage applied to the developer bearing member 44 and the charged potential of the photosensitive drum 1 to suppress the fog.

The developer on the developer bearing member 44 is conveyed to the inside of the developing container while being maintained to be attracted to the surface of the developer bearing member 44 by the magnetic pole N2 for conveyance. Further, the developer conveyed to the inside of the developing container is separated from the developer bearing member 44 by the magnetic pole S3 for separation.

In the developing device 4, the developing device memory 90 (see FIG. 3) as a setting storing portion is provided. The developing device memory 90 is a non-volatile memory provided in the developing device 4. In the developing device memory 90, the production number of the developing device, the production date, total amount of working time, and the information on whether the developing device is new or not are stored.

### Basic Configuration of Replenishing Device

The configuration of the replenishing device will be described referring to FIG. 6. FIG. 6 is a schematic diagram showing the configuration of the replenishing device. The configuration of the replenishing device is based on the configuration that the replenishing conveying path 83 extends from the discharge port 82 of the toner accommodating container 8 to the replenishing port 43 of the developing device 4.

As described above, the image forming apparatus 100 has the replaceable toner accommodating container 8 that accommodates developer to be replenished to the developing device 4. The control portion 10 performs a control such that the developer is replenished from the toner accommodating container 8 to the developing device 4 to maintain a toner density of the developer accommodated in the developing device 4 based on the output voltage outputted from the magnetic permeability sensor 45.

The replenishing developer is accommodated in the toner accommodating container 8. The toner rate (for example, 90%) of the replenishing developer accommodated in the toner accommodating container 8 is larger than the carrier rate (for example, 10%) of that replenishing developer.

In the developing device 4, the replenishing port 43 is provided at the most upstream side of the stirring chamber 41b and outside the developer circulating path. The developer in the developer circulating path is almost not present on the developer conveying member in the vicinity of the replenishing port 43 but only the replenishing developer replenished from the toner accommodating container 8 passes through. The replenishing port 43 communicates with the lower end portion of the replenishing conveying path 83, which is a pipe member with a square cross-section. The upper end portion of the pipe member with the square cross-section communicates with the discharge port 82 of the toner accommodating container 8.

The toner accommodating container 8 has the configuration in which a spiral groove is formed on the inner wall of the cylindrical container so that a conveying force is produced in the longitudinal direction and the replenishing developer is conveyed to the discharge port 82 when the toner accommodating container 8 rotates. The replenishing developer having been conveyed to the discharge port 82 is discharged to the replenishing conveying path 83 via the discharge port 82 by the air pressure produced by the pump 81 that can change the volume of the toner accommodating container 8 and reaches the replenishing port 43 of the developing device 4 via the replenishing conveying path 83.

### Magnetic Permeability Sensor

Next, the magnetic permeability sensor 45 will be described. As described above, the developer used in the present embodiment is a dual-component developer with non-magnetic toner and magnetic carrier. When the toner density of the developer changes, the magnetic permeability changes due to the change in the mixture rate of non-magnetic toner and magnetic carrier. Therefore, by detecting the change in the magnetic permeability with the magnetic permeability sensor 45, the toner density of the developer can be detected. The magnetic permeability sensor 45 used in the present embodiment can output an output voltage according to the change in magnetic permeability of the developer, i.e., toner density by utilizing the inductance of a coil.

Not shown in the figure, the four bundles of wires, namely, the bundle of wires for application of a predetermined power supply voltage (for example, 5.0 [V]), the bundle of wires for application of control voltage, the bundle of wires for grounding, and the bundle of wires for output voltage are connected to the magnetic permeability sensor 45. The power supply voltage is applied to the magnetic permeability sensor 45 from the sensor power supply and control portion 70 (see FIG. 3). A control voltage is applied to the magnetic permeability sensor 45 in the state where the power supply voltage is applied. The magnetic permeability sensor 45 detects the magnetic permeability of the developer (i.e., toner density of the developer) present in the vicinity of the sensor surface 45s in the state where the voltage is applied from the sensor power supply and control portion 70.

The magnetic permeability sensor 45 is installed on the downstream side of the stirring chamber 41b as shown in FIG. 5. The magnetic permeability sensor 45 is configured to detect the magnetic permeability of the developer that has been sufficiently stirred with the developer circulated from the developing chamber 41a to the stirring chamber 41b and the replenishing developer newly replenished from the replenishing port 43 being mixed with each other. As a result, wrong detection of toner density due to lack of stirring is avoided.

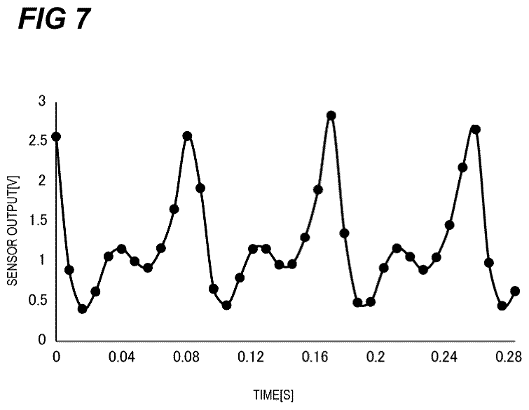

The magnetic permeability sensor 45 detects the developer that is stirred by the screw member 41e in the stirring chamber 41b at time intervals in the order of one millisecond. There are points of time when the amount of developer in the vicinity of the sensor surface 45s is larger and points of time when the amount of developer in the vicinity of the sensor surface 45s is smaller due to the shape of the spiral blade of the screw member 41e. Therefore, when the output voltage [V] of the magnetic permeability sensor 45 is plotted with time (s) indicated on the horizontal axis, the wave shape is as shown in FIG. 7. In the present embodiment, the average for three wavelengths is taken as the output voltage of the magnetic permeability sensor 45 and treated as a detection result. In all the controls performed in the present embodiment using a detection result of the magnetic permeability sensor 45, a detection result with this treatment is used.

When the toner density of the developer in the developing device 4 becomes low, the rate of the magnetic carrier included in the developer in a unit volume in the vicinity of the sensor surface 45s relatively increases so that the apparent magnetic permeability of the developer becomes high and the output voltage of the magnetic permeability sensor 45 becomes high. Conversely, when the toner density of the developer becomes high, the rate of the magnetic carrier included in the developer in a unit volume in the vicinity of the sensor surface 45s relatively decreases so that the apparent magnetic permeability of the developer becomes low and the output voltage of the magnetic permeability sensor 45 becomes low.

Even when the developer with the same toner density is present in the vicinity of the sensor surface 45s, the output voltage outputted from the magnetic permeability sensor 45 changes depending on the bulk density of the developer. For example, in the high temperature and high humidity environment, the toner charging amount of the developer decreases so that the coulomb repulsion forces between toner particles or between carrier particles decrease and the bulk density of the developer increases. Conversely, in the low temperature and low humidity environment, the toner charging amount of the developer increases so that the coulomb repulsion forces between toner particles or between carrier particles increase and the bulk density of the developer decreases. Therefore, when the developer with the same toner density is used, the output voltage is likely to become higher in the in the high temperature and high humidity environment than in the low temperature and low humidity environment.

Further, when the rotational speed of developer bearing member 44 or screw members 41d, 41e is changed according to a change in a process speed, for example, in a case when the recording material is changed from a sheet of plain paper to a sheet of thick paper, the bulk density of the developer in the vicinity of the sensor surface 45s of the magnetic permeability sensor 45 can also change. Specifically, the bulk density tends to increase when the rotational speed of the developer bearing member 44 or screw members 41d, 41e becomes lower.

The control voltage applied to the magnetic permeability sensor 45 is changed (for example, in the range of 3.0 to 5.0 [V]) in order to properly detect the density according to the environment where the image forming apparatus 100 is installed (for example, temperature, humidity, absolute moisture amount), and the process speed.

### Initializing Control Process

Next, the initializing control for the developing device 4 will be described referring to FIG. 8. FIG. 8 is a flowchart of the initializing control process of the developing device 4.

As described above, the magnetic permeability sensor for detecting toner density is attached to the developing device. The magnetic permeability sensor is capable of outputting an output voltage corresponding to the magnetic permeability of the developer while being provided with voltages. However, a difference occurs in the relationship between the control voltage and the output voltage in each magnetic permeability sensor attached to the developing device due to the variations of the magnetic permeability sensor itself, variations in installation of the magnetic permeability sensor to the developing device, variations in the control voltage applied to the magnetic permeability sensor and so on. In this case, even if the same control voltage is applied to respective magnetic permeability sensors, the respective magnetic permeability sensors output different output voltages from each other. As a result, different values can be detected as the toner density although the toner density is the same. This means that the toner density may not be properly detected.

In order to deal with this situation, the control portion 10 is capable of performing the initializing mode for adjusting (setting) a control voltage applied to the magnetic permeability sensor 45 such that the same output voltage is output for the developer with the same toner density. This initializing mode is used for initializing the magnetic permeability sensor 45 when the image forming apparatus 100 is installed for the first time after the shipment from the factory or when the developing device 4 is exchanged to a new one. In this initializing mode, the initializing control process shown in FIG. 8 is performed.

The initializing flag ON is stored in the developing device memory 90 of the new developing device 4 at the time of shipment. Namely, when the initializing flag ON is stored in the developing device memory 90 of the developing device 4, it is found that the developing device 4 is a new one and contains the initial developer with a predetermined toner density. A toner density of the initial developer is previously adjusted to the target density at the shipment from the factory so that the initial developer has the predetermined toner density. Further, the new developing device 4 contains the initial developer whose carrier rate (for example, 90%) is higher than the toner rate (for example, 10%).

After the power supply of the image forming apparatus 100 is turned on, when the control portion 10 detects the initializing flag ON in the developing device memory 90 (step S101), the control portion 10 judges that the developing device 4 is a new one and starts the initializing control (step S102).

Next, the control portion 10 drives the screw members of the developing device 4 and the performs the operation for stirring the initial developer for a predetermined time period (for example, 1 [min]) to stabilize the charging amount of the developer accommodated in the developing device 4 (step S103). At this time, voltages are applied to the developer bearing member 44 and the photosensitive drum 1 to produce a potential difference between them in order to prevent the toner density to change due to the toner in the developer flying to the photosensitive drum 1.

Next, the control portion 10 changes the control voltage applied to the magnetic permeability sensor 45 a little by little (for example 0.1 [V] steps) in a predetermined range and obtains the output voltages output accordingly from the magnetic permeability sensor 45. The initial developer whose toner density has been previously adjusted to the target density at the shipment from the factory is accommodated in the new developing device 4. The control voltage at which the predetermined output voltage (2.0 [V] in the present embodiment) is obtained, which is previously determined corresponding to the target density in a new developing device 4 at the shipment from factory is set to the control voltage Vcnt1 applied to the magnetic permeability sensor 45 in order to properly detect the toner density (step S104). The set control voltage Vcnt1 and the initial flag OFF are stored in the developing device memory 90 (step S105), and the initializing control process is completed (step S106).

As described above, the initial flag ON is stored in the developing device memory 90 of the developing device 4 when the developing device 4 is a new one and the initializing mode is not performed. In contrast, the initial flag OFF is stored in the developing device memory 90 of the developing device 4 when the developing device 4 is not a new one and the initializing mode has been performed. Namely, the developing device memory 90 of the developing device 4 has the information on whether the initializing mode is performed or not.

In the present embodiment, the decision is made about the start of the initializing control based on the initial flags in the developing device memory 90. However, the present invention is not limited to this configuration, and the initializing control may be started by manually pressing a button on the image forming apparatus after the exchange of the developing devices.

### Replenishing Amount Control

The replenishment of the developer to the developing device 4 according to the present embodiment is performed under the ATR control. In this replenishing control, the toner amount and status of the developer are detected and presumed, based on this, the replenishing control portion 150 calculates necessary replenishing amount, and the developer is automatically replenished to the developing device 4 at proper timing. Namely, the developer is replenished to the developing device 4 at the timing when a lump of developer whose toner density decreases after toner is consumed by image formation circulates in the developing device 4 and reaches the vicinity of the replenishing port 43.

In the ATR control according to the present embodiment, the calculation of replenishing amount by presumption of toner consumption using video count value and the calculation of replenishing amount performed based on a detection result of the toner density by the magnetic permeability sensor 45 are combined to calculate the toner amount to be replenished. In the following, the calculation of replenishing amount (replenishing amount control) by presumption of toner consumption using video count value is referred to as video count replenishing control, and the calculation of replenishing amount (replenishing amount control) performed based on a detection result of the toner density by the magnetic permeability sensor 45 is referred to as inductance replenishing control.

The toner density output target value to aim at is not constant and is always corrected by the toner patch control that is appropriately performed. The toner patch control is performed as follows. Namely, a toner patch is formed on the intermediate transfer belt 51 under the latent image conditions determined by the initializing control process, and the density is detected by the toner patch density sensor 55 (see FIGS. 2 and 3). By performing this toner patch control as appropriate, the toner density output target value to aim at continues to be corrected. The toner patch density sensor 55 irradiates the toner patch formed on the intermediate transfer belt 51 with light using LED (Light Emitting Diode), and measures the density of the toner patch by detecting the light amount of reflected light (normal reflection light or irregular reflection light).

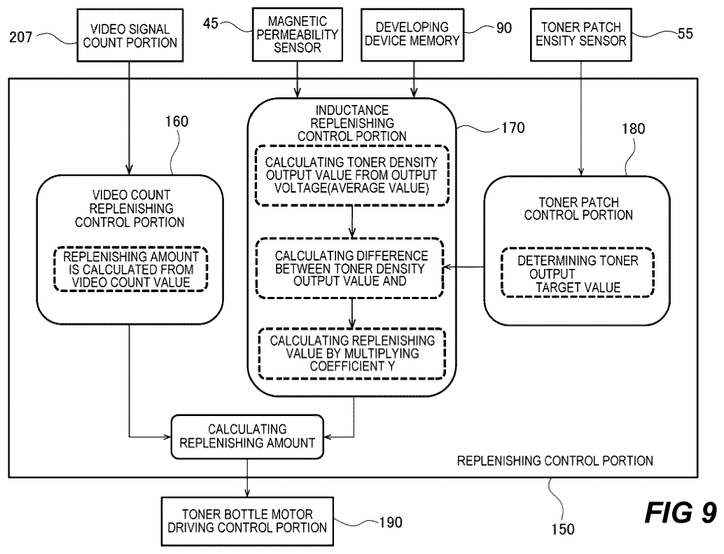

The detailed system configuration for the video count replenishing control and the inductance replenishing control will be described referring to FIGS. 3 and 9. FIG. 9 is a block diagram showing the system configuration of the toner replenishing control of the image forming apparatus. The toner replenishing amount is calculated by combining the calculated amount from the video count replenishing control and the calculated amount from the inductance replenishing control in the unit of mass of developer [mg].

In the video count replenishing control, first, the video count value acquired in the video signal count portion 207 of the control portion 10 is sent to the video count replenishing control portion 160 of the replenishing control portion 150. The video count value is converted to the mass of developer to be replenished by the conversion table of the video count replenishing control portion 160 to calculate the replenishing amount based on it. In contrast, in the inductance replenishing control, the output voltage output by the magnetic permeability sensor 45 according to the toner density is input to the inductance replenishing control portion 170 of the replenishing control portion 150. The output voltage value is A-D converted in the inductance replenishing control portion 170 to become a 8-bit digital signal value (this digital signal value is hereinafter referred to as toner density output value). The replenishing amount is calculated by the difference between the toner density output value and the toner density output target value being multiplied by the inductance replenishing coefficient Y. As described above, the toner density output target value is determined in the toner patch control portion 180 of the replenishing control portion 150 according to the output value of the toner patch density sensor 55.

The replenishing amount calculated by combining the replenishing amounts calculated in the video count replenishing control portion 160 and the inductance replenishing control portion 170 is sent to the toner bottle motor driving control portion 190 so that the toner accommodating container 8 is operated to replenish the necessary replenishing amount. The video count replenishing control is a feedforward control and the replenishing amount is always calculated as a positive value. In contrast, the inductance replenishing control is a feedback control, the toner density in the developing device 4 is detected by the magnetic permeability sensor 45, and the replenishing amount is calculated as a positive vale or a negative value. The excess or deficiency of the replenishing amount in the video count replenishing control is adjusted by the inductance replenishing control to suppress the toner density in the developing device 4 from fluctuating.

### Sensitivity Correction of Magnetic Permeability Sensor

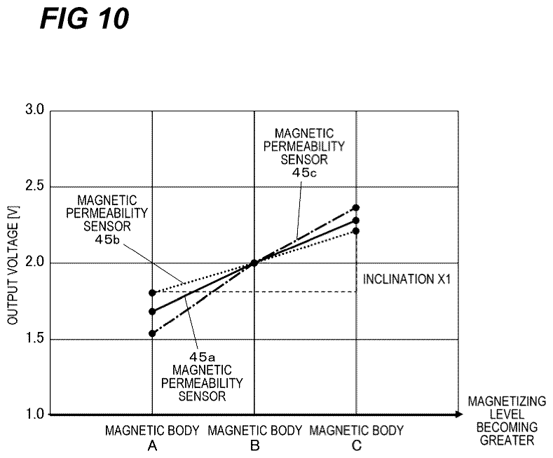

There are individual variations in sensitivity of the magnetic permeability sensor 45 and accordingly there are individual variations in the output value of the magnetic permeability sensor 45 for developer having the same toner density. FIG. 10 is a graph showing the output values of the magnetic permeability sensors 45a, 45b, and 45c when the magnetic permeability sensors 45a, 45b, and 45c are brought near the magnetic bodies A, B, and C having different magnetization levels where the sensitivity of the magnetic permeability sensor 45b is lower than that of the magnetic permeability sensor 45a as reference and the sensitivity of the magnetic permeability sensor 45c is higher than that of the magnetic permeability sensor 45a as reference. In this case, the voltages applied to the magnetic permeability sensors 45a, 45b, and 45c are adjusted such that the output values of the magnetic permeability sensors 45a, 45b, and 45c become 2.0 [V] when the magnetic permeability sensors 45a, 45b, and 45c are brought near the magnetic body B.

It is understood from FIG. 10 that the calculated replenishing amount should be corrected because the detected magnetization level, or the toner density in the developing device 4 differs due to the variations in sensitivity of the magnetic permeability sensors 45 even if the output values of the magnetic permeability sensors 45 are the same as each other. Sensitivities of the magnetic permeability sensors 45 are measured in the production process by bringing the magnetic permeability sensors 45 near the magnetic bodies A, B, and C having different magnetization levels and the data are acquired similarly as shown in FIG. 10. Based on the data, the inclination values of the graphs of the magnetic permeability sensors 45 are calculated and stored in the developing device memory 90 of the developing device 4 as sensitivities X1 of the magnetic permeability sensors 45. The sensitivity of the magnetic permeability sensor 45a as reference is set as X0.

The replenishing amount of the above described inductance replenishing control is calculated by the following equation using the correction coefficient Y that has been previously verified and calculated while changing the toner density of the developer in the developing device 4 with the magnetic permeability sensor 45a as reference.

The replenishing amount=(output value of toner density−output target value of toner density)×Y×X0/X1.

The sensitivity of the magnetic permeability sensor 45, which is the sensitivity characteristics inherent to the magnetic permeability sensor 45 is stored in the developing device memory 90 of the developing device 4. The control portion 10 calculates the replenishing amount from the above equation. Namely, the control portion 10 calculates the replenishing amount of the replenishing developer from the toner accommodating container 8 to the developing device 4 based on the output value of the magnetic permeability sensor and the sensitivity characteristics of the magnetic permeability sensor, which is inherent to the magnetic permeability sensor.

### Control Process of Image Forming Apparatus

The characteristic control process of the image forming apparatus 100 according to the present embodiment will be described next. In the image forming apparatus 100 according to the present embodiment, a control voltage to the magnetic permeability sensor 45 is reset when the second hand developing device 4 that has been used in another image forming apparatus is installed and used in the image forming apparatus 100.

As described above, the optimum values for the control voltage to the magnetic permeability sensor 45 changes due to individual variations of magnetic permeability sensors 45, variations in installation of the magnetic permeability sensor to the developing sensor 4, and variations in the control voltage. Therefore, in a case where a second hand developing device that has been used in another image forming apparatus is installed and used in the image forming apparatus 100, when the control voltage that is determined in the initializing control process is used, the voltages applied to the magnetic permeability sensor 45 may shift from the optimum value due to variations in control voltages of the image forming apparatus. The precise toner density of the developer accommodated in a second hand developing device is not known so that the initializing control process cannot be performed again.

For example, the initial developer accommodated in a new developing device has a toner rate of 10% and a carrier rate of 90%. In contrast, the initial developer is not accommodated in a second hand developing device and even when developer is accommodated, the toner density of the developer is not known. The developer accommodated in a second hand developing device has a different carrier rate than that of the initial developer. For example, the developer accommodated in a second hand developing device has a toner rate of 8% and a carrier rate of 92%.

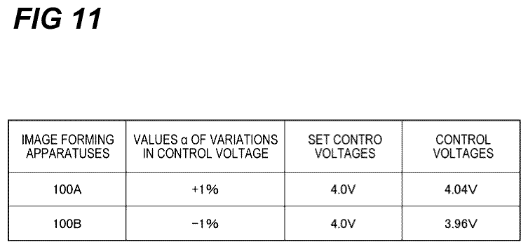

Therefore, in the image forming apparatus according to the present embodiment, the measurement of the sensor power supply and control portion 70 is performed in the production process in advance and the set value of the control voltage is corrected based on the variations in the stored control voltage inherent to the image forming apparatus. The value α of variations of control voltage that is measured in the production process at a factory is stored in the RAM 211 as a main body memory of the image forming apparatus. As indicated in FIG. 11, for example, a voltage value of the control voltage applied to the magnetic permeability sensor 45 changes with respect to the previously set control voltage according to the value α of variations in the control voltage stored in the RAM 211.

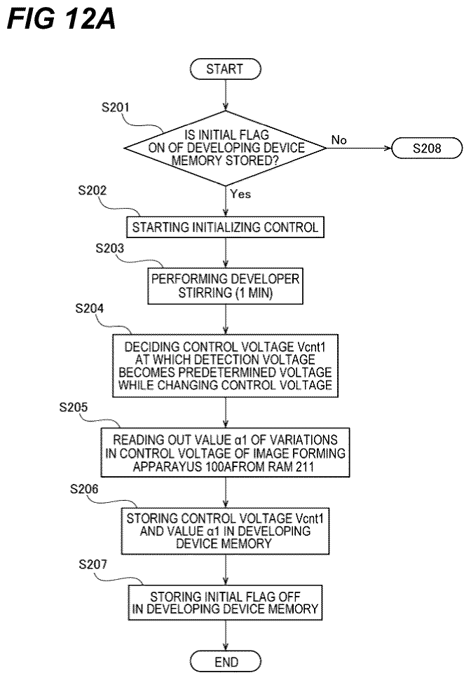

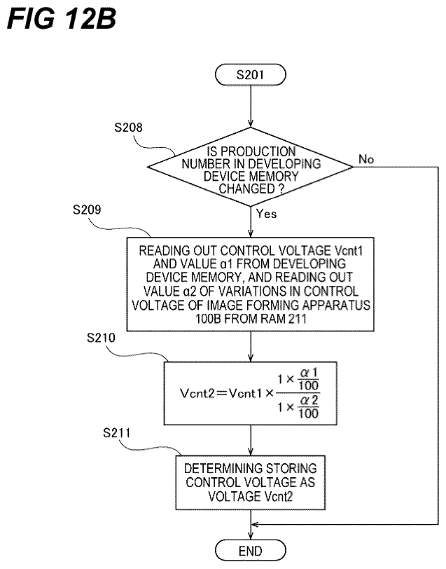

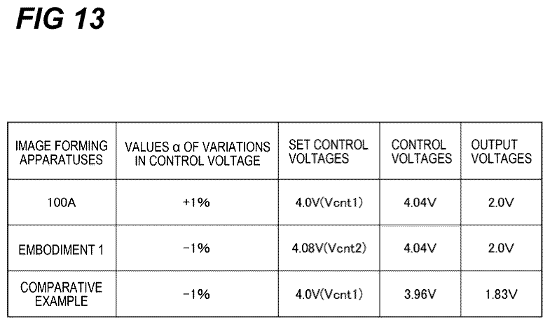

Next, the setting of the control voltage in a case where the developing device 4 has been used in the image forming apparatus 100A is used in the image forming apparatus 100B will be described referring to FIGS. 12A to 13. FIGS. 12A and 12B is a flowchart showing the setting control of the control voltage to the magnetic permeability sensor 45 according to Embodiment 1 of the present invention. FIG. 13 is a table showing results of the setting of the control voltage to the magnetic permeability sensor 45 according to Embodiment 1 of the present invention.

First, the initial installing flow of a new developing device 4 (step S201 to S207 in FIG. 12A) will be described. The steps S201, S202, S203, S204 are respectively the same as the steps S101, S102, S103, S104 shown in FIG. 8 and the description thereof will be omitted.

After the control voltage Vcnt1 to be applied to the magnetic permeability sensor 45 is determined (step S204), the value α1 [%] of variations of control voltage is read out from the RAM 211 of the image forming apparatus 100A (step S205). The determined control voltage Vcnt1 and the read-out value α1 [%] of variations of control voltage are stored in the developing device memory 90 of the developing device 4 (step S206). Then, the initial flag OFF is stored in the developing device memory 90 of the developing device 4 to complete the initializing control (step S207).

The operation of the initializing control so far is the same as that described using FIG. 8 except that the value α1 of variations of control voltage is read out from the RAM 211 and stored in the developing device memory 90. The replenishing control during a normal operation is also the same using the control voltage Vcnt1.

Next, the operation in a case where the second hand developing device 4 that has been used in another image forming apparatus is installed in the image forming apparatus 100B will be described.

After the image forming apparatus 100B is turned on, when the control portion 10 detects the initial flag OFF in the developing device memory 90 (step S201), the control portion 10 judges that the developing device 4 installed in the image forming apparatus 100B is a second hand one. Since the initial flag OFF is stored in the developing device memory 90 of the developing device 4 in the step S207, this developing device 4 has been subjected to the initializing control from the step S202 to S207.

When the control portion 10 detects the initial flag OFF in the developing device memory 90 (step S201), the control portion 10 confirms whether the production number that is inherent to developing device stored in the developing device memory 90 of the developing device 4 has been changed from that in the developing device having been previously operating or not (step S208).

The production number inherent to developing device is exemplified as the identification number inherent to the developing device stored in the developing device memory 90 of the developing device 4. However, the present invention is not limited this.

When the production number inherent to developing device stored in the developing device memory 90 of the developing device 4 has not been changed, the developing device 4 has not been exchanged and the control portion 10 returns to the normal operation with the control voltage Vent maintained as it is.

In contrast, when the control portion 10 identifies that another developing device 4 is installed from the production number inherent to the developing device stored in the developing device memory 90 of the developing device 4 (step S208), the control portion 10 resets the control voltage (steps S209 to S211).

The control portion 10 reads out the control voltage Vcnt1 [V] and the value α1 [%] of variations in the control voltage from the developing device memory 90 of the developing device 4 that has been subjected to the initializing mode, and the reads out the value α2 [%] of variations in the control voltage from the RAM 211 of the image forming apparatus 100B (step S209).

The control voltage Vcnt1 [V] stored in the developing device memory 90 of the developing device 4 that has been subjected to the initializing mode is the control voltage set in the initializing mode of the other image forming apparatus 100A. The value α1 [%] of variations in the control voltage in the developing device memory 90 has been read out from the RAM 211 of the other image forming apparatus 100A and has been stored in the developing device memory 90 when the initializing mode has been performed in the other image forming apparatus 100A.

The control portion 10 calculates the optimum control voltage Vcnt2 by the following Equation 1 based on the control voltage Vcnt1 [V], the value α1 [%] of variations in the control voltage, and the value α2 [%] of variations in the control voltage (step S210).

$$Vcnt 2 = Vcnt 1 \times ( 1 + α1 / 100 ) / ( 1 + α2 / 100 ) \qquad ( Equation 1 )$$

The control voltage Vcnt2 [V] calculated by Equation 1 is the control voltage applied to magnetic permeability sensor 45 of the developing device that has been subjected to the initializing mode. Namely, the control voltage Vcnt2 [V] is the control voltage applied to the developing device 4 when the developing device 4 that has been used in the other image forming apparatus 100A is installed in the image forming apparatus 100B and used.

The control portion 10 sets the calculated control voltage Vcnt2 [V] to the developing device memory 90 of the developing device 4 that has been subjected to the initializing mode (step S211) and returns to the normal operation.

For example, when the initializing control is performed in the image forming apparatus 100A with the value α1 [%] of variations in the control voltage being equal to 1.0 [%] such that the output voltage becomes 2.0 [V], the control voltage Vcnt1 to the magnetic permeability sensor 45 of the developing device 4 installed in the image forming apparatus 100A becomes 4.0 [V]. The developing device 4 whose developing device memory 90 stores the control voltage Vcnt1 [V] and the value α1 [%] of variations in the control voltage is installed in the image forming apparatus 100B with the value α2 [%] of variations in the control voltage being equal to −1.0 [%]. In this case, the control voltage Vcnt2 [V] set in Embodiment 1 and the control voltage Vcnt1 [V] set in the comparative example are shown in the table of FIG. 13.

The control voltage Vcnt2 [V] in Embodiment 1 is calculated by performing the control process shown in FIGS. 12A and 12B. In contrast, the control voltage Vcnt1 [V] in the comparative example is set by performing the control process shown in FIG. 8, in which variations in control voltage of an image forming apparatus are not corrected.

In the image forming apparatus 100B as the comparative example, even if a control voltage is set to the control voltage Vcnt1, the actual control voltage to be applied to the magnetic permeability sensor 45 becomes less than the value used in the image forming apparatus 100A due to variations in control voltage. Accordingly, regardless of the fact that the toner density of the developer in the developing device 4 is not changed, an output voltage from the magnetic permeability sensor becomes less.

In contrast, in the image forming apparatus 100B in Embodiment 1, the control voltage Vcnt1 that has been determined in the initializing control of the image forming apparatus 100A is corrected into the control voltage Vcnt2 using the value α of variations in the control voltage. Therefore, even when the developing device 4 that has been detached from the other image forming apparatus 100A is installed and reused in the image forming apparatus 100B, the control voltage applied to the magnetic permeability sensor 45 in the image forming apparatus 100B can be properly set and the same output voltage can be obtained.

According to the present invention, even when the developing device 4 that has been detached from another image forming apparatus 100A is installed and reused in the image forming apparatus 100B, the toner density can be properly detected by magnetic permeability sensor 45. Namely, even when the developing device 4 that has been subjected to the initializing mode is installed and reused in another image forming apparatus 100, the toner density can be properly detected by the magnetic permeability sensor 45 so that the developer can be maintained at the optimum toner density.

### Embodiment 2

Next, the image forming apparatus according to Embodiment 2 of the present invention will be described referring to figures. The schematic configurations of the image forming apparatus, the developing device, the replenishing device, the magnetic permeability sensor are the same as those of Embodiment 1 and the description thereof will be omitted. In the present embodiment, the same reference characters are attached as those of Embodiment 1 to the components having the same functions as those of Embodiment 1.

### Control Process of Image Forming Apparatus

In Embodiment 1, a second hand developing device 4 that has been used in another image forming apparatus is installed and used in the present image forming apparatus, the control voltage to the magnetic permeability sensor 45 is reset by correcting variations in control voltage to the magnetic permeability sensor 45.

In the image forming apparatus 100 according to the present embodiment, the control process of resetting control voltage to the magnetic permeability sensor 45 in a case where a second hand developing device 4 that has been used in another image forming apparatus is installed and used is different from that of Embodiment 1. In the following, the control process of the image forming apparatus 100 characteristic to the present embodiment will be described.

As described above, with the magnetic permeability sensor 45 being provided with a predetermined power supply voltage (for example, 5.0 [V]) from the sensor power supply and control portion 70, the control voltage (Vent) is also provided, so that the magnetic permeability sensor 45 can output the output voltage whose value changes according to the toner density of the developer.

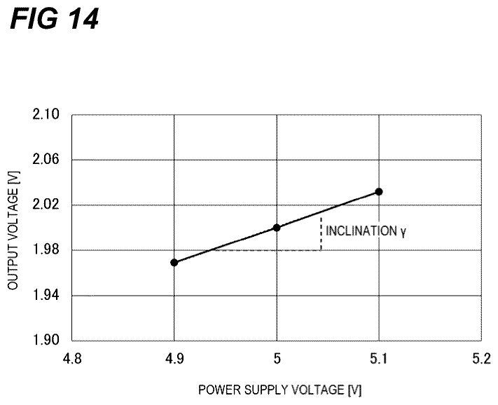

In the present embodiment, variations in power supply voltage of respective image forming apparatuses to be applied to the magnetic permeability sensor 45 are additionally corrected to further suppress shifts in replenishing control. In the present embodiment, the magnetic permeability sensor 45 is brought near the above described magnetic body B (see FIG. 10) to measure the output voltage (output value) during the production process of the developing device 4. Then, with the control voltage being adjusted such that the output voltage becomes 2.0 [V] in the state where the precise power supply voltage 5.0 [V] is being applied to the magnetic permeability sensor 45, the output value is measured while the power supply voltage is changed to 4.9 [V] and 5.1 [V]. FIG. 14 shows the relationship between power supply voltage [V] and the output voltage (output value) [V] as results of the measurement. The sensitivity 7 (inclination) of power supply voltage is measured in the production process in advance and is stored in the developing device memory 90 of the developing device 4.

Further, in advance, the power supply voltage of the sensor power supply and control portion 70 is set to the predetermined value (for example, 5.0[V]), the actually applied power supply voltage value is measured in the production process, and the actual power supply voltage β [V] as the measured value is stored in the RAM 211. As described above, the value α of variations in control voltage that is measured in the production process in the factory is stored in the RAM 211 as a main body memory of the image forming apparatus. Therefore, the value α2 of variations in control voltage applied from the sensor power supply and control portion 70 to the magnetic permeability sensor 45 and the actual power supply voltage β2 that is actually applied to the magnetic permeability sensor 45, which are measured in the production process are stored in the RAM 211 of the image forming apparatus 100B.

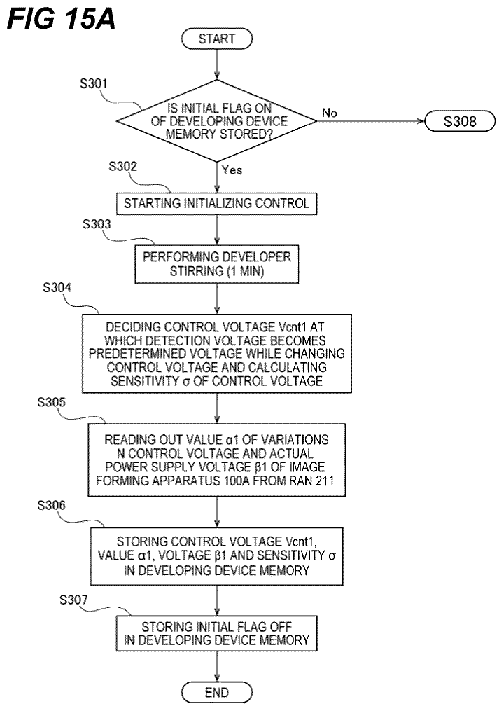

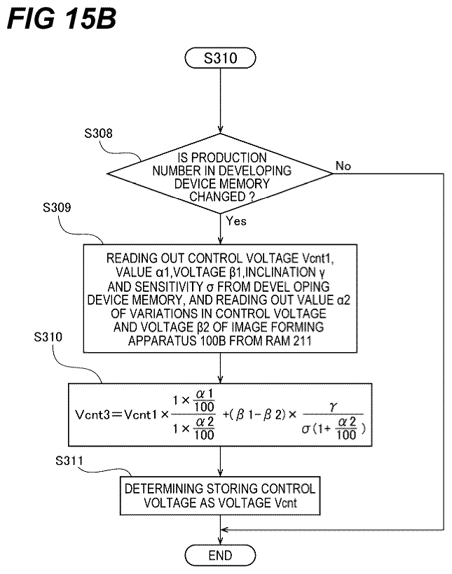

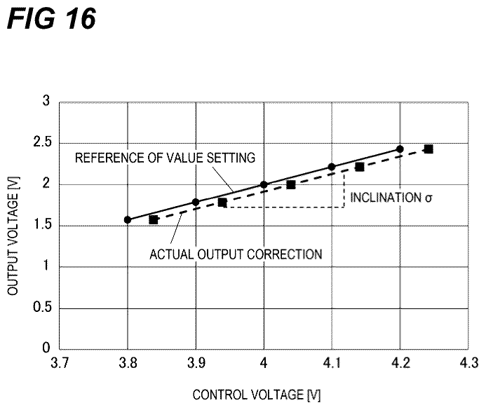

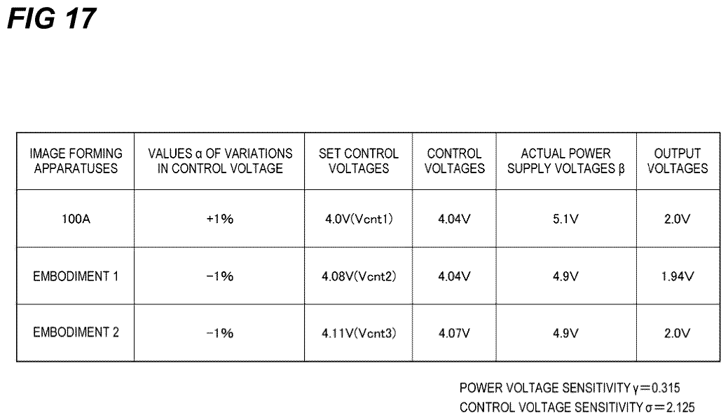

The setting of the control voltage in a case where the developing device 4 that has been used in another image forming apparatus 100A is used in the image forming apparatus 100B will be described referring to FIGS. 15A to 17. FIGS. 15A and 15B is a flowchart showing the setting control of control voltage to be applied to magnetic permeability sensor 45 according to Embodiment 2. FIG. 16 is a graph showing the relationship between the control voltage and the output voltage of the magnetic permeability sensor 45 according to Embodiment 2. FIG. 17 is a table showing the setting results of the control voltage to the magnetic permeability sensor 45 according to Embodiment 2.

First, the initial installation flow (steps S301 to S307 in FIG. 15A) of a new developing device 4 will be described. The operations of the steps S301, S302, and S303 shown in FIGS. 15A and 15B are the same as those of the steps S101, S102, and S103 shown in FIG. 8 and description thereof will be omitted.

The control voltage Vcnt1 to be applied to the magnetic permeability sensor 45 is determined similar to the step S104 and the sensitivity a of the control voltage shown in FIG. 16 is determined (step S304). The solid line in FIG. 16 shows the output value (output voltage [V]) of the magnetic permeability sensor 45 with respect to the set value (control voltage Vent [V]) in the step S304. The broken line in FIG. 16 shows the output value (output voltage [V]) of the magnetic permeability sensor 45 with respect to the actual output of the control voltage corrected by multiplying the control voltage Vent by the value α1 [%] of variations in control voltage. The inclination of the output value shown by the broken line is the sensitivity a.

Next, the value α1 [%] of variations in control voltage and the power supply voltage β1 [V] are read out from the RAM 211 of the image forming apparatus 100A (step S305). The determined control voltage Vcnt1 [V], the read-out value α1 [%] of variations of control voltage and the actual power supply voltage β1 [V], and the sensitivity a of the control voltage are stored in the developing device memory 90 of the developing device 4 (step S306). Then, the initial flag OFF is stored in the developing device memory 90 of the developing device 4 to complete the initializing control (step S307).

Next, the operation in a case where the second hand developing device 4 that has been used in another image forming apparatus 100A is installed in the image forming apparatus 100B will be described.

After the image forming apparatus 100B is turned on, when the control portion 10 detects the initial flag OFF in the developing device memory 90 of the installed developing device 4 (step S301), the control portion 10 judges that the developing device 4 installed in the image forming apparatus 100B is a second hand one. Since the initial flag OFF is stored in the developing device memory 90 of the developing device 4 in the step S307, this developing device 4 has been subjected to the initializing control from the step S302 to S307.

When the control portion 10 detects the initial flag OFF in the developing device memory 90 (step S301), the control portion 10 confirms whether the production number that is inherent to developing device stored in the developing device memory 90 of the developing device 4 has been changed from that in the developing device having been previously operating or not (step S308).

When the production number inherent to the developing device stored in the developing device memory 90 of the developing device 4 has not been changed, the developing device 4 has not been exchanged and the control portion 10 returns to the normal operation with the control voltage Vent maintained as it is.

In contrast, when the control portion 10 identifies that another developing device 4 is installed from the production number inherent to the developing device stored in the developing device memory 90 of the developing device 4 (step S308), the control portion 10 resets the control voltage (steps S309 to S311).

The control portion 10 reads out the control voltage Vcnt1 [V], the value α1 [%] of variations in the control voltage, the actual power supply voltage β1 [V], and the sensitivity σ of the control voltage from the developing device memory 90 of the developing device 4 that has been subjected to the initializing mode (step S309). Further, the control portion 10 reads out the value α2 [%] of variations in the control voltage and the actual power supply voltage β2 [V] from the RAM 211 of the image forming apparatus 100B (step S309).

The control voltage Vcnt1 [V] and the sensitivity σ of the control voltage stored in the developing device memory 90 of the developing device 4 that has been subjected to the initializing mode are the control voltage and the sensitivity of the control voltage set in the initializing mode of the other image forming apparatus 100A. The value α1 [%] of variations in the control voltage in the developing device memory 90 is read out from the RAM 211 of the other image forming apparatus 100A and got stored in the developing device memory 90 when the initializing mode is performed in the other image forming apparatus 100A. The actual power supply voltage β1 [V] in the developing device memory 90 is read out from the RAM 211 of the other image forming apparatus 100A and got stored in the developing device memory 90 when the initializing mode is performed in the other image forming apparatus 100A. The sensitivity 7 of power supply voltage of the magnetic permeability sensor 45 stored in the developing device memory 90 is the previously measured sensitivity of output voltage when the power supply voltage to be supplied to the magnetic permeability sensor 45 measured in advance in the production process changes.

The control portion 10 calculates the optimum control voltage Vcnt3 by the following Equation 2 based on the control voltage Vcnt1 [V], the sensitivity σ of the control voltage, the sensitivity 7 of power supply voltage, the value α1 [%] of variations in the control voltage, the actual power supply voltage β1 [V], the value α2 [%] of variations in the control voltage, and the actual power supply voltage β2 [V](step S310).

$$Vcnt 3 = Vcnt 1 \times ( 1 + α1 / 100 ) / ( 1 + α2 / 100 ) + ( β1 - β2 ) \times γ / ( σ ( 1 + α2 / 100 ) ) \qquad ( Equation 2 )$$

The control voltage Vcnt3 [V] calculated by Equation 2 is the control voltage applied to magnetic permeability sensor 45 of the developing device 4 that has been subjected to the initializing mode. Namely, the control voltage Vcnt3 [V] is the control voltage applied to the developing device 4 when the developing device 4 that has been used in the other image forming apparatus 100A is installed in the image forming apparatus 100B and used.

The control portion 10 sets the calculated control voltage Vcnt3 [V] to the developing device memory 90 of the developing device 4 that has been subjected to the initializing mode (step S311) and returns to the normal operation.

For example, when the initializing control is performed in the image forming apparatus 100A with the value α1 [%] of variations in the control voltage being equal to 1.0 [%] and the actual power supply voltage β1 being equal to 5.1 [V] such that the output voltage becomes 3.0 [V], the control voltage Vcnt1 to the magnetic permeability sensor 45 of the developing device 4 installed in the image forming apparatus 100A becomes 4.04 [V]. The developing device 4 whose developing device memory 90 stores the control voltage Vcnt1 [V], the value α1 [%] of variations in the control voltage, and the actual power supply voltage β1 [V] is installed in the image forming apparatus 100B with the value α2 [%] of variations in the control voltage being equal to −1.0 [%] and the actual power supply voltage β2 being equal to −4.9 [V]. In this case, the control voltage Vcnt3 [V] set in Embodiment 2 and the control voltage Vcnt2 [V] set in Embodiment 1 are shown in the table of FIG. 17.

The control voltage Vcnt3 [V] set in Embodiment 2 is calculated by performing the control process shown in FIGS. 15A and 15B. In contrast, the control voltage Vcnt2 [V] in Embodiment 1 is set by performing the control process shown in FIGS. 12A and 12B.

In this case, the image forming apparatus 100B according to Embodiment 1 has the sensitivity 7 of power voltage being equal to 0.315 and the sensitivity σ of control voltage being equal to 2.125. In the image forming apparatus 100B according to Embodiment 1, even if the control voltage is set to the control voltage value Vcnt2 [V], the actual voltage applied to the magnetic permeability sensor 45 becomes less than the value used in the image forming apparatus 100A due to variations of power supply voltage. As a result, although the toner density of the developer in the developing device 4 does not change, the output voltage of the magnetic permeability sensor becomes lower.

In contrast, in the image forming apparatus 100B according to Embodiment 2, the control voltage Vcnt1 determined in the initialization control of the image forming apparatus 100A is corrected to the control voltage Vcnt3 based on the value α of variations in the control voltage, and variations of power supply voltage (the actual power supply voltage β). As a result, even when the developing device 4 that is detached from another image forming apparatus 100A is installed and reused in the image forming apparatus 100B, the control voltage applied to the magnetic permeability sensor 45 is properly set in the image forming apparatus 100B and the same output voltage can be obtained.

According to the present invention, even when the developing device 4 that has been detached from the image forming apparatus 100A is installed and reused in another image forming apparatus 100B, the toner density can be properly detected by magnetic permeability sensor 45. Namely, even when the developing device 4 that has been subjected to the initializing mode is installed and reused in another image forming apparatus 100, the toner density can be properly detected by the magnetic permeability sensor 45 so that the developer can be maintained at the optimum toner density.

In the above described Embodiments 1 and 2, information stored in the developing device memory 90 attached to the developing device 4 is used for correcting the control voltage Vcnt. The memory portion is not limited to such a physical memory medium. For example, various pieces of information of the developing device 4 of the image forming apparatus 100 may be stored on the cloud connected to the internet.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-129142, filed Aug. 8, 2023, which is hereby incorporated by reference herein in its entirety.

1. A developing device detachably attachable to an image forming apparatus, comprising:
a developer bearing member that bears developer including toner and carrier for developing an electronic latent image formed on an image bearing member;
a developing container that accommodates the developer;
a magnetic permeability sensor capable of outputting an output voltage according to a toner density of the developer accommodated in the developing container by a voltage being applied to the magnetic permeability sensor; and
a storing portion that stores information on output characteristics of a power supply of an image forming apparatus that has performed an initializing mode for determining a control voltage to be applied to the magnetic permeability sensor by the power supply of the image forming apparatus in order to detect a toner density of the developer accommodated in the developing device.

2. The developing device according to claim 1,
wherein the storing portion further stores information on the control voltage determined in the initializing mode.

3. The developing device according to claim 1,
wherein the storing portion further stores information on output characteristics of a power supply of the magnetic permeability sensor.

4. The developing device according to claim 1,
wherein the storing portion further stores information on whether the developing device is new or not.

5. The developing device according to claim 1,
wherein the storing portion further stores information inherent to the developing device, which is uniquely specifiable of the developing device.

6. The developing device according to claim 5,
wherein the information inherent to the developing device is a production number of the developing device.

7. An image forming apparatus comprising:
an image bearing member;
a developing device detachably attachable to the image forming apparatus, the developing device comprising: a developer bearing member that bears developer including toner and carrier for developing an electronic latent image formed on the image bearing member; a developing container that accommodates the developer; a magnetic permeability sensor capable of outputting an output voltage according to a toner density of the developer accommodated in the developing container by a voltage being applied to the magnetic permeability sensor; and a storing portion;
a power supply that applies a voltage to the magnetic permeability sensor;
a main body storing portion that stores information on output characteristics of the power supply; and
a control portion capable of performing an initializing mode for determining a control voltage to be applied to the magnetic permeability sensor by the power supply in order to detect a toner density of the developer accommodated in the developing device by detecting an output voltage output from the magnetic permeability sensor to which the power supply applies the voltage,
wherein in a case where the initializing mode has not been performed for the developing device attached to the image forming apparatus, the control portion performs the initializing mode, and the control portion reads out the information on output characteristics of the power supply stored in the main body storing portion and stores in the storing portion the information as information on output characteristics of a power supply of an image forming apparatus that has performed the initializing mode.

8. The image forming apparatus according to claim 7,
wherein in a case where the initializing mode has not been performed for the developing device attached to the image forming apparatus, the control portion further stores the control voltage determined in the initializing mode in the storing portion.

9. The image forming apparatus according to claim 8,
wherein in a case where the initializing mode has been performed for the developing device attached to the image forming apparatus and the developing device is different from a developing device previously attached to the image forming apparatus, the control portion determines a control voltage to be applied to the magnetic permeability sensor by the power supply for detecting a toner density of the developer accommodated in the developing container based on the control voltage determined in the initializing mode and stored in the storing portion, the information on output characteristics of a power supply of an image forming apparatus that has performed the initializing mode stored in the storing portion, and the information on output characteristics of the power supply stored in the main body storing portion.

10. The image forming apparatus according to claim 8,
wherein the storing portion further stores information on output characteristics of a power supply of the magnetic permeability sensor, and
wherein in a case where the initializing mode has been performed for the developing device attached to the image forming apparatus and the developing device is different from a developing device previously attached to the image forming apparatus, the control portion determines a control voltage to be applied to the magnetic permeability sensor by the power supply for detecting a toner density of the developer accommodated in the developing container based on the control voltage determined in the initializing mode and stored in the storing portion, the information on output characteristics of a power supply of an image forming apparatus that has performed the initializing mode stored in the storing portion, the information on output characteristics of a power supply of the magnetic permeability sensor stored in the storing portion, and the information on output characteristics of the power supply stored in the main body storing portion.

11. The image forming apparatus according to claim 7,
wherein the storing portion further stores information on whether the developing device is new or not.

12. The image forming apparatus according to claim 7,
wherein the storing portion further stores information inherent to the developing device, which is uniquely specifiable of the developing device.

13. The image forming apparatus according to claim 12,
wherein the information inherent to the developing device is a production number of the developing device.
